(19) United States
(12) Patent Application Publication
(10) Pub. No.: US 2009/0010324 A1
(43) Pub. Date: Jan. 8, 2009

(54) DECODING APPARATUS AND DECODING METHOD WITH EFFICIENT RESPONSE TO CHANNEL SWITCHING

(75) Inventor: Hirotsugu YAMAMOTO, Tokyo (JP)

Correspondence Address: FITCH EVEN TABIN AND FLANNERY, 120 SOUTH LA SALLE STREET, SUITE 1600, CHICAGO, IL, 60603-3406, US

(73) Assignee: Sony Computer Entertainment Inc., Minato-ku (JP)

(21) Appl. No.: 12/137,305

(22) Filed: Jun. 11, 2008

(30) Foreign Application Priority Data
Jul. 4, 2007 (JP) 2007-176790

(51) Int. Cl. H04B 1/66

(52) U.S. Cl. 375/240.01; 375/E07.001

(57) ABSTRACT

A broadcast signal receiving system includes a decoder. The decoder is provided with a first processing system and a second processing system. The first processing system is provided with a first demodulator and a first decoder. The second processing system is provided with a second demodulator and a second decoder. One of the processing systems demodulates and decodes a signal corresponding to a channel selected by a user using a controller and displayed on a display device. The other processing system demodulates and decodes a signal corresponding to a channel predicted by a channel predicting unit to be selected next by the user. When the predicted channel is selected by the user, an output controlling unit switches the source of output of data stream for generating an image to be output to the display device so as to select the processing system that had been processing in the selected channel as a source.

### CROSS REFERENCE TO RELATED APPLICATION

The present application claims priority from Japanese Patent Application Serial No. JP2007-176790, filed Jul. 4, 2007, the disclosure of which is hereby incorporated by reference herein in its entirety.

### BACKGROUND OF THE INVENTION

1. Field of the Invention

The present invention relates to information processing technologies for decoding broadcast signals and, more particularly, to a decoding apparatus and a decoding method applied to the apparatus which allow images of a channel selected from a plurality of channels to be displayed on a display device.

2. Description of the Related Art

With the development of information processing technologies in recent years, environments in which contents including images, music, characters, and the like are delivered have also changed. For example, in the field of television broadcasting, terrestrial digital broadcasting services are becoming increasingly active in addition to satellite digital broadcasting. As a result, users can now enjoy a variety of high-quality, highly-useful contents. In digital broadcasting, compression-coded signals are delivered and so a technology capable of receiving and decoding the signals is called for in order to view a program.

A commonly used television receiver for digital broadcasting extracts a television signal of a channel selected by a user from among television signals for a plurality of channels included in broadcast signals, and generates and outputs image data and audio data by subjecting the extracted signal to demodulation and decoding. Unlike the case of information processing where a single pre-loaded content file is decoded and reproduced, the user who receive broadcast signals including a plurality of channels may frequently switch channels in order, for example, to search for a desired program.

Accordingly, a television receiver is preferably adapted to track channel switching operations so as to generate and output image data and audio data for a channel selected by switching. Meanwhile, various processes have to be performed, beginning with the reception of a signal of a new channel selected by switching and ending with the output of data, with the result that there is a time lag between an instruction for switching and the output of data. The problem occurs not only with television signals but also with radio reception, audio reproduction, and observation of experimental data so long as an environment exits in which a plurality of kinds of serial data that vary in the time domain are received simultaneously and one of the kinds of data is selected and reproduced.

### SUMMARY OF THE INVENTION

In this background, a general purpose of the present invention is to provide a technology which allows smooth switching between channels while receiving broadcast images, without incurring a substantial increase in the cost.

One embodiment of the present invention relates to a decoding apparatus. The decoding apparatus is adapted to decode a signal corresponding to a channel selected by a user, generate output data based upon resultant decoded data, and output the output data to a device connected to the decoding apparatus, the signal being included in broadcast signals, and comprises: a plurality of decoders operative to decode signals corresponding to a plurality of channels, including the selected channel, the signal being included in the broadcast signals; an output controlling unit operative to control the destination of output of the decoded data generated by the plurality of decoders so that the output data is generated based upon the decoded data corresponding to the selected channel; and a channel predicting unit operative to predict a channel to be selected next every time the user selects a channel, wherein one of the plurality of decoders decodes the signal corresponding to the selected channel, and the other decoders decode the signals corresponding to the channels predicted by the channel predictor.

In addition to the ordinary process of decoding data streams (e.g., decoding of MPEG-Transport Streams (TS)), “decoding” as performed by the “decoder” may encompass any of the processes necessary to generate, from the broadcast signals, the data ultimately output. For example, signal extraction or channel demodulation may be encompassed.

Another embodiment of the present invention relates to a decoding method. The decoding method is adapted for a decoding apparatus, and comprises: 1) outputting data which is obtained by decoding a signal corresponding to a channel selected by a user to a device connected to the decoding apparatus, the signal being included in broadcast signals; 2) decoding, in parallel with step 1), a signal corresponding to a channel predicted to be selected next; and 3) switching the destination of output so that data obtained by decoding the signal corresponding to the predicted channel in step 2) is output to the device, when the user selects the channel predicted.

Optional combinations of the aforementioned constituting elements, and implementations of the invention in the form of methods, apparatuses, systems, and computer programs may also be practiced as additional modes of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a schematic timing chart covering a period between a channel selection input and display of an image in a commonly used television receiver;

FIG. 2 shows the structure of a broadcast image receiving system according to an embodiment of the present invention;

FIG. 3 is a flowchart showing the procedure including a channel switching process in a decoding apparatus of the embodiment;

FIG. 4 shows an exemplary configuration of the control panel of a controller of the embodiment;

FIG. 5 is a flowchart showing how a channel predicting unit according to the present embodiment predicts a channel to be selected next; and

FIG. 6 is a schematic timing chart covering a period between a channel selection input and display of an image according to the embodiment.

### DETAILED DESCRIPTION OF THE INVENTION

The invention will now be described by reference to the preferred embodiment. This does not intend to limit the scope of the present invention, but to exemplify the invention.

An embodiment of the invention is directed to a technology for decoding broadcast signals such as terrestrial digital broadcast television signals for display on a display device. In order to define the features of the embodiment clearly, a description will initially be given of a decoding process commonly practiced in digital broadcasting. The processing procedure and process details explained herein are by way of example only and do not limit the scope of the present embodiment. To facilitate the understanding, the description given below only concerns processes related to image data included in digital broadcast signals. However, similar processes are applicable to audio data, text data, and the like.

In digital broadcasting, digital data of respective channels is subjected to the orthogonal frequency division multiplexing (OFDM) and compression coding according to MPEG-2. The data is also subject to 64 quadrature amplitude modulation (64 QAM) before being delivered. The demodulator and decoder in a television receiver for viewing digital broadcasting respectively perform demodulation and decoding of frequency domain signals corresponding to the respective channels. Images thus generated are displayed on a display device.

In this process, the demodulator identifies a channel selected by a user operation of a remote controller and extracts a frequency domain signal corresponding to the selected channel from broadcast signals, using a bandpass filter or the like. The demodulator then performs demodulation by subjecting the extracted signal to analog-to-digital conversion, OFDM decoding, QAM decoding, error correction, etc.

The resultant data stream is temporarily stored in a stream buffer. In MPEG-2, a data stream includes intra-coded pictures (I pictures) subjected to intraframe coding, predicted pictures (P pictures) subjected to forward interframe predictive coding, which uses past frames as reference images, and bi-directional predicted pictures (B pictures) subjected to bi-directional interframe predictive coding, which uses past and future frames as reference images. By allowing the decoder to decode the pictures sequentially, data for an image to be ultimately displayed can be obtained.

Every time a user provides an input for selection of a channel in an ordinary television receiver as described above, the frequency domain signal corresponding to the newly selected channel is extracted from the broadcast signals and subjected to demodulation and decoding. For this reason, a time lag occurs between the input for selection of a channel and the display of the image of the selected channel due to the above-mentioned processes. In the compression coding technology like MPEG which uses interframe prediction, particularly, it is necessary to process a plurality of correlated frame data items to create image frames that are ultimately displayed. Time lag may be so long that it cannot be tolerated.

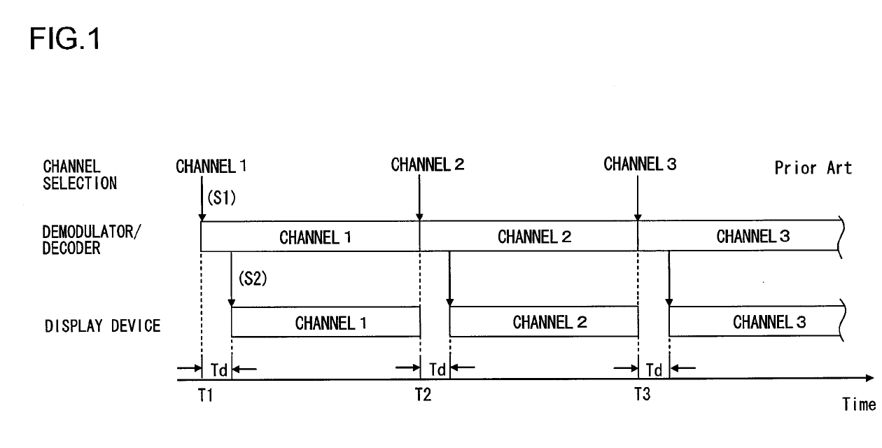

FIG. 1 is a schematic timing chart covering a period between a channel selection input and display of an image in a commonly used television receiver. Referring to FIG. 1, the horizontal axis represents a time axis which is common to the events. The figure depicts the timing of inputs for channel selection, processes in the demodulator and the decoder, and display on the display device. When an input for selection of “channel 1” is provided at time T1 (S1), the demodulator and the decoder extract the signal corresponding to the selected channel from the broadcast signals and start demodulation and decoding the signal.

The demodulator and the decoder complete the generation of image data and output the data to the display device when time Td has elapsed since time T1 (S2). The lag is due to the fact that, as described above, it takes time to perform the processes necessary to generate image data and to wait for the arrival of data such as I picture data that is necessary to generate the image data. Consequently, the image of “channel 1” is displayed on the display device when time Td has elapsed since time T1.

Similarly, even though the inputs for selection of “channel 2” and “channel 3” are provided at time T2 and time T3, and the demodulator and the decoder started demodulating and decoding the signals corresponding to the channels at these times respectively, the images of these channels are displayed on the display device with a delay of time Td from time T2 and time T3, respectively. In a majority of cases, a time lag period Td is turned into a blackout period in which the display device does not display anything so that the user can recognize that an input for channel selection is accepted.

However, occurrence of a time lag creates a lot of stress for users. For example, when the user wants to learn what programs are broadcast over the channels by switching between channels at short intervals, i.e., when the user wants to do channel zapping, it would be hard to switch between channels at a speed desired by the user and the efficiency of zapping is lowered if a blackout period occurs every time the channel is switched. The present embodiment reduces the frequency of occurrence of time lags between the switching of the channel and the display of the image so as to produce a decoding method which is not likely to give stress to the user. The inventive method takes advantage of the existing structure of ordinary television receivers so that the cost for implementation is restricted.

More specifically, in addition to a processing system for demodulating and decoding a signal corresponding to the channel currently selected by the user, there is also provided a processing system for demodulating and decoding a signal corresponding to a channel predicted to be selected next by the user concurrently with the processing in the former system. Hereinafter, the former system will be referred to as a main processing system and the latter will be referred to as a sub-processing system. Image data decoded in the sub-processing system is not displayed on a display device unless the corresponding channel is selected by the user. In this embodiment, occurrence of time lags in switching the channel is eliminated as much as possible by operating the sub-processing system in a speculative manner.

Many television receivers and tuners available recently are provided with two or more processing systems for demodulation and decoding for the purpose of, for example, recording a program other than the one being viewed (i.e., a program in a competing timeslot). By allowing one of the processing systems to operate as a main processing system according to the embodiment and the other as a sub-processing system according to the embodiment, the frequency of time lags is reduced while minimizing the use of additional hardware. Occurrence of time lags is effectively minimized using limited resources by predicting a channel that the user is likely to select next according to a predetermined algorithm. The specific method of prediction will be discussed in detail later.

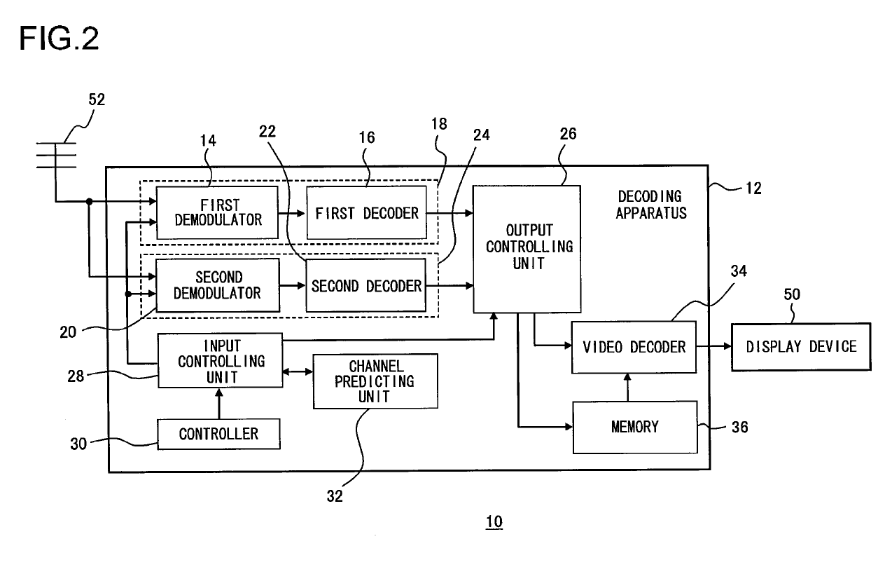

FIG. 2 shows the structure of a broadcast signal receiving system according to the embodiment. A broadcast signal receiving system 10 includes a decoding apparatus 12 and a display device 50. The decoding apparatus 12 receives a broadcast signal such as that of digital broadcasting from the antenna 52. The decoding apparatus 12 subjects the received signal to demodulation and decoding so as to generate image data and output the data to the display device 50. The display device 50 displays the image data output by the decoding apparatus 12 as an image. The decoding apparatus 12 and the display device 50 may be embodied as one unit or separate devices connected by cables.

The antenna 52 may be a terminal for connecting to a network so as to acquire contents data delivered over the network. A skilled person would appreciate that processes performed in the decoding apparatus 12, including demodulation and decoding which will be described below, may vary depending on the data format of contents data.

The elements illustrated in FIG. 2 as functional blocks for performing respective processes may be implemented in hardware by a CPU, a memory, or other LSI's, and in software by a program or the like implementing a decoding process. Therefore, it will be obvious to those skilled in the art that the functional blocks may be implemented in a variety of manners including, without limitation, by hardware only, software only, or a combination of thereof.

The decoding apparatus 12 includes a first processing system 18 comprising a first demodulator 14 and a first decoder 16, and a second processing system 24 comprising a second demodulator 20 and a second decoder 22. The first processing system 18 and the second processing system 24 are switchably used as the main processing system or the sub-processing system. More specifically, one of the first processing system 18 and the second processing system 24 demodulates and decodes a signal corresponding to the channel selected by the user, and the other demodulates and decodes a signal corresponding to the channel predicted to be selected next. The systems 18 and 24 output data streams of the respective channels.

Given that the broadcast signal received is an MPEG-2 digital broadcast signal, the process performed by each of the first demodulator 14 and the second demodulator 20 may be a demodulating process performed in an ordinary television receiver as discussed earlier. The process performed by each of the first decoder 16 and the second decoder 22 may be a decoding process performed in an ordinary television receiver. Therefore, each of the first demodulator 14, the second demodulator 20, the first decoder 16, and the second decoder 22 may appropriately include a plurality of functional blocks, buffers, and memories as would be provided in ordinary demodulators and decoders. Illustration of these components is, however, omitted. Alternatively, the demodulators and decoders may determine the specifics of the process depending on the coding format of an input signal.

As mentioned above, the two processing systems provided respectively for display and for recording in television receivers or tuners may be used as the first processing system 18 and the second processing system 24. Alternatively, two processing systems exclusively implementing the embodiment may be provided. Yet alternatively, two or more sub-processing systems may be provided by providing three or more processing systems each comprising a demodulator and a decoder. In the following description, a single sub-processing system is assumed. However, the advantages are also provided by similarly processing signals in two or more sub-processing systems.

The decoding apparatus 12 further includes a controller 30 which accepts an input for channel selection from the user, an input controlling unit 28 which controls the channels subject to processing by the first processing system 18 and the second processing system 24, a channel predicting unit 32 which predicts a channel to be selected next by the user, an output controlling unit 26 which switches to one of the data streams output from the two processing systems for output to the display device 50, a video decoder 34 which converts the data stream to conform to the display format of the display device 50, and a memory 36 which temporarily stores the data stream corresponding to the predicted channel.

The controller 30 may be shaped like a remote controller used in ordinary television receivers. For example, the controller 30 may include, without limitation, channel number designation buttons provided for respective channel numbers, and channel up/down buttons comprising two buttons to select larger and smaller channel numbers, respectively. Alternatively, the present embodiment may include a numeric keypad for entering a channel number or a pointing device for selecting from thumbnails displayed on the display device 50 to represent respective channels or from a list of channel numbers displayed. The controller 30 may be provided with a plurality of such input means. Hereinafter, various input means used for input to the controller 30 will alternatively be referred to as a “module” of the controller 30.

In this embodiment, the first processing system 18 and the second processing system 24 are basically alternately used as a main processing system and as a sub-processing system. The input controlling unit 28 changes over between the processing systems, alternately designating one of them as a main processing system and the other a sub-processing system, every time the controller 30 accepts an input for channel selection. The input controlling unit 28 outputs the result of switching to the output controlling unit 26. If the newly selected channel is different from the channel that had been processed in the sub-processing system, i.e., if the prediction fails, the input controlling unit 28 causes the sub-processing system to process the newly selected channel before changing over between the main-processing system and the sub-processing system. The channel predicting unit 32 is supplied with information related to the input for channel selection by the input controlling unit 28 and predicts a channel to be selected next. The predicted channel is set as a new subject of processing in the processing system currently turned into a sub-processing system.

The channel predicting unit 32 predicts a channel to be selected next based upon the information related to the input for channel selection and obtained from the input controlling unit 28. The channel predicting unit 32 notifies the input controlling unit 28 of the predicted channel. The information related to the input for channel selection and used in prediction may be the type of the module of the controller 30 used for the input as well as the newly selected channel number. Still alternatively, a history of the channels selected may be stored and used for prediction. A specific example will be given later.

The output controlling unit 26 outputs to the video decoder 34 the data stream output from one of the first processing system 18 and the second processing system 24 turned into a main processing system by the input controlling unit 28. The output controlling unit 26 outputs the data stream output from the sub-processing system to the memory 36. When the input controlling unit 28 changes over between the main processing system and the sub-processing system, the output controlling unit 26 changes the destination of the output of data stream accordingly. In this way, the source of the output of data stream for creating images ultimately displayed is changed between the first processing system 18 and the second processing system 24.

The video decoder 34 subjects the data stream output from the main processing system via the output controlling unit 26 to ordinary video decoding processes such as color decoding and picture control in compliance with the signal system of the display device 50. The video decoder 34 outputs the resultant image data to the display device 50. The video decoder 34 may be implemented by a video decoder provided in ordinary television receivers.

The memory 36 temporarily stores, in the limited amount, the data stream output from the sub-processing system via the output controlling unit 26. For example, the memory 36 may store a single group of pictures (GOP), discarding a previous GOP as a new GOP is output from the sub-processing system. When the user selects the predicted channel, image data is temporarily created from the data for the selected channel stored in the memory 36 and is displayed accordingly. In this way, the image of the channel to which the user switched can be displayed on the display device 50 without delay, without waiting for the output of the subsequent data stream.

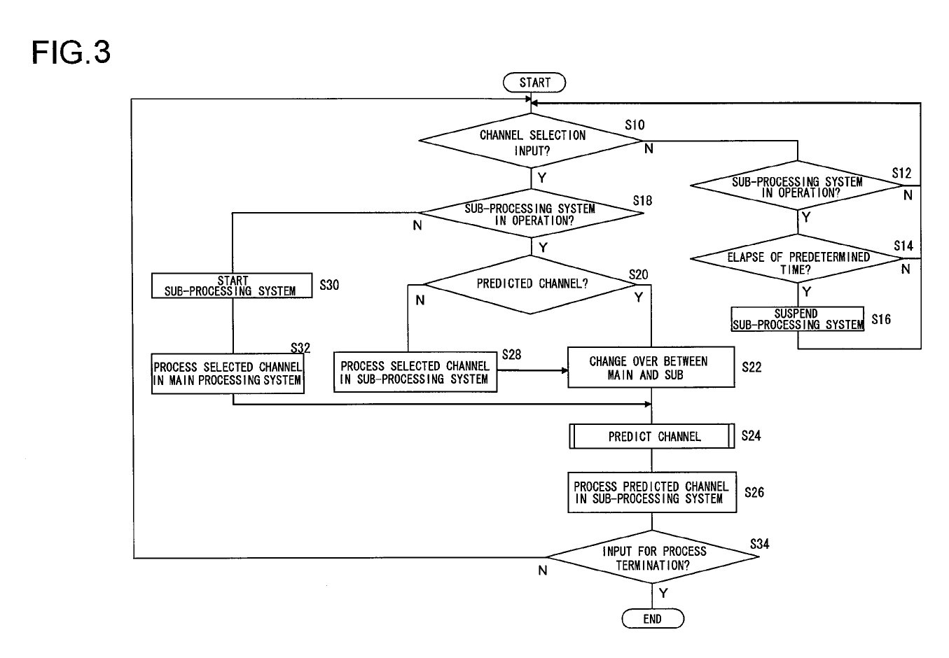

A description will now be given of the operation of the decoding apparatus 12 implemented as described above. FIG. 3 shows the processing procedure including the steps of switching the channel in the decoding apparatus 12 according to this embodiment. In the figure, it is assumed that a signal corresponding to a channel selected by the user is being demodulated and decoded in the main processing system (the first processing system 18 or the second processing system 24) at the time of starting the flow and that the image of that channel is being displayed on the display device 50.

If a predetermined period of time elapses since the last input for channel selection is supplied by the user to the controller 30 (Y in S14) while there is no input for channel selection (N in S10) and while the sub-processing system is in operation (Y in S12), the operation of the sub-processing system is suspended (S16). In a situation where the user does not switch the channel frequently in an attempt to, for example, zap channels, the frequency of channel switching is low in itself so that there would not be much stress on the user due to time lags. Occurrence of such a situation is identified by referring to the elapsed time. By suspending the sub-processing system, reduction in power consumption is prioritized over reduction in the frequency of time lags.

The “predetermined period of time” is a period such as a duration of time which warrants a prediction that the user will continue to view the same program subsequently. The predetermined period of time may be preset by statistically analyzing the trend in timing and frequency of channel selections. Alternatively, the time may be dynamically redefined by referring to the history of switching by individual users.

If the sub-processing system is not in operation (N in S12), the current state is maintained unless there is an input for channel selection (N in S10). If the sub-processing system is in operation (Y in S12) and a predetermined period of time has not elapsed since the last input for channel selection (N in S14), the current state is maintained until there is an input for channel selection and the elapsed time continues to be measured (N in S10, Y in S12, and N in S14).

If the user supplies an input for channel selection to the controller 30 in this situation (Y in S10) and if the sub-processing system is in operation (Y in S18), it means that the sub-processing system is performing demodulation and decoding in the predicted channel. If the predicted channel is the same as the channel selected by the user in S10 (Y in S20), the input controlling unit 28 directs the output controlling unit 26 to change over between the main processing system and the sub-processing system (S22).

For example, given that the first processing system 18 had been the main processing system and the second processing system 24 had been the sub-processing system, the input controlling unit 28 directs the first processing system 18 to be the sub-processing system and directs the second processing system 24 to be the main processing system. In this process, the input controlling unit 28 stores the associated information in a register (not shown) provided in the controlling unit 28 and also notifies the output controlling unit 26 accordingly. In association with this, the output controlling unit 26 effects changeover so as to feed the data stream output from the second processing system 24, turned into the main processing system, to the video decoder 34 and to store the data stream output from the first processing system 18, turned into the sub-processing system, in the memory 36. Further, the output controlling unit 26 controls the video decoder 34 to read the data stored in the memory 36 and convert the data into image data immediately after the changeover. As a result, the image data of the newly selected channel is immediately output to the display device 50.

Meanwhile, the input controlling unit 28 supplies the channel predicting unit 32 with information such as the channel number selected in S10 and the identity of the module in the controller 30 used to provide the input for channel selection. The channel predicting unit 32 predicts a channel to be selected next, based upon the information. The input controlling unit 28 sets up the predicted channel number in the processing system (the first processing system 18 in the example described above), turned into the sub-processing system, allowing the sub-processing system to perform demodulation and decoding in the predicted channel (S26). Thereafter, the steps following Y in S10, Y in S18, Y in S20, and step S22 are repeated, given that the selected channel is as predicted. Thereby, occurrence of time lags at the time of switching the channel is eliminated.

If it is determined in S20 that the channel originally predicted is different from the channel selected by the user (N in S20), the input controlling unit 28 controls the sub-processing system to initiate demodulation and decoding in the newly selected channel (S28), before changing over between the main processing system and the sub-processing system (S22). Subsequent channel prediction and demodulation and decoding in the predicted channel in the sub-processing system are the same as those of S24 and S26, respectively. Demodulation and decoding in the selected channel performed in S28 may be initiated in the main processing system. In this case, the changeover in S22 between the main processing system and the sub-processing system is not performed.

If the sub-processing system is not in operation when there is an input for channel selection (N in S18), the sub-processing system is started (S30). At the same time, the input controlling unit 28 controls the main processing system to initiate demodulation and decoding in the newly selected channel (S32). In this case, a change only occurs in the channel to be processed by the main-processing system. Therefore, changeover between the main processing system and the sub-processing system is not performed. Subsequent channel prediction and demodulation and decoding in the predicted channel in the sub-processing system thus started are the same as those of S24 and S26, respectively.

The above steps are repeated until the user supplies an input for termination of the process (e.g., turn-off of the power supply for the decoding apparatus 12) to the controller 30, etc. (N in S34). If a prediction of a channel fails (N in S20) or if the sub-processing system is suspended (N in S18), a time lag as would occur in ordinary television receivers may occur when switching the channel. In this case, as described in relation to ordinary television receivers, the output data may be controlled so that the display device 50 blacks out. Alternatively, the image data of the channel selected prior to the switching may continue to be output by delaying the changeover between the main processing system and the sub-processing system in S22.

A description will now be given of algorithms for predicting a channel to be selected. As mentioned above, the more successful the prediction of a channel by the channel predicting unit 32, the more frequently time lags are prevented from occurring when the channel is switched. For accurate prediction, it is preferable to use information other than the channel number selected immediately before. For example, the history of channel selection listing a plurality of channel numbers previously selected, or the type of the module of the controller 30 used by the user to provide an input for channel selection, may be used.

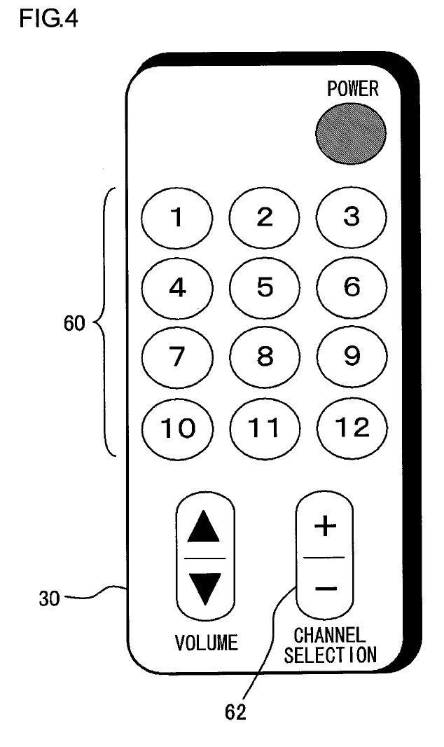

FIG. 4 shows an exemplary configuration of the control panel of the controller 30. The controller 30 shown in FIG. 4 is provided with two types of modules as means for providing an input for channel selection: channel number designation buttons 60 and channel up/down buttons 62. As described above, the channel number designation buttons 60 comprise individual buttons provided for the respective channel numbers. The user directly selects a channel by pressing one of the buttons. In the illustrated example, a total of twelve buttons labeled “1” through “12” are provided. The channel up/down buttons 62 comprises two buttons that select larger and smaller channel numbers, respectively. In the illustrated example, a larger channel number is selected by pressing the “+” key and a smaller channel number is selected by pressing the “−” key.

When the user provides an input for a channel selection using the channel up/down button 62, the user often presses one of the buttons continuously instead of pressing the two buttons in a random manner. This is because it is more efficient to flip through channels in one direction regardless of whether a target channel is already determined or the user wishes to zap through the entire channels for a quick scan. It is generally presumed that the user will use the channel up/down buttons 62 in a majority of cases for zapping. As described above, the problem of time lags associated with channel switching is likely to manifest itself in performing zapping. Therefore, the advantage from reducing time lags by channel prediction will be more vividly appreciated by taking advantage of the aforementioned tendency associated with using the channel up/down buttons 62 for prediction of a channel.

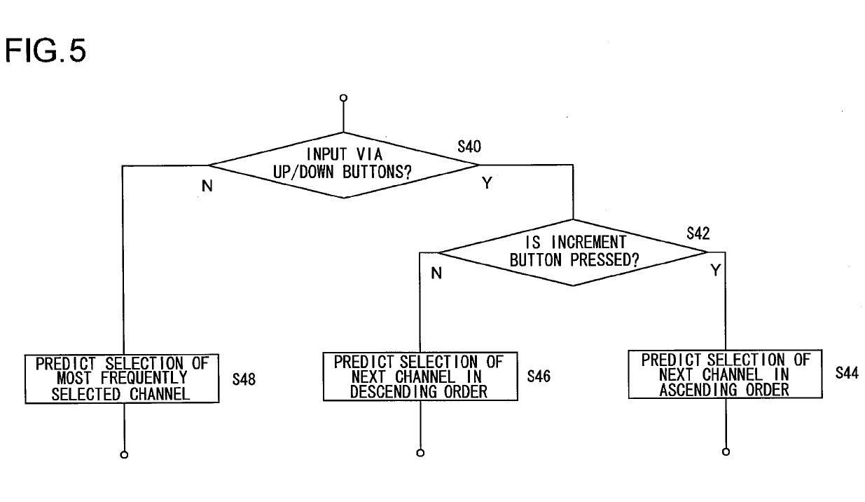

FIG. 5 is a flowchart showing a method whereby the channel predicting unit 32 predicts a channel to be selected next in S24 of FIG. 3. It is reasoned that there is a tendency as described above in the user's intention as reflected in the selective use of the channel number designation buttons 60 and the channel up/down buttons 62 of the controller 30 configured as shown in FIG. 4, and in the way these controls are used. Therefore, the tendency is utilized for efficient prediction in this method.

If the user provides an input for channel selection using the channel up/down buttons 62 (Y in S40), a distinction is made between which of the increment button or the decrement button is pressed (S42). If the increment button is pressed (Y in S42), it is assumed that the same button will be pressed next. A prediction is made that the channel having the channel number that follows the currently-selected channel number in the ascending order will be selected (S44). Similarly, if the decrement button is pressed (N in S42), a prediction is made that the channel having the channel number that follows the currently-selected cannel number in the descending order will be selected (S46).

If the user does not provide an input for channel selection using the channel up/down buttons 62 (N in S40), i.e., when the user directly enters an channel number by using, for example, the channel number designation buttons 60 in FIG. 4, a prediction is made recursively based upon, for example, the history of selection. For example, a prediction is made that the channel selected most frequently during a predetermined period of time recently will be selected next (S48). The predetermined period of time may be as short as one minute or as long as one week or more. A final prediction may be rendered by weighting the frequency in various time frames. Alternatively, prediction may be based upon a model such as an autoregressive prediction model commonly used in statistics. Depending on the model or prediction method used, the channel predicting unit 32 may be provided with a memory (not shown) for storing the history of channel selection over a predetermined period of time.

If, for example, the user is more or less interested in a program in a competing timeslot while viewing a program, two of the channel number designation buttons 60 will be pressed alternately during a period of time of, for example, one hour. In this case, the frequency of the two channels being selected will be high during a relatively short period of time. It can be predicted therefore that the channel selected immediately before the currently selected channel was selected will be selected next by referring to the history of selection over a period of time of about one hour. In this case, smooth channel switching is enabled because the channels processed in the first processing system 18 and the second processing system 24 remain unchanged, and switching is effected merely by letting the output controlling unit 26 to switch the source of the output of data stream to the video decoder 34.

Meanwhile, selection of a channel can be efficiently narrowed down in consideration of the user's preference (channels hardly ever viewed by the user, channels preferentially viewed by the user, etc.) by referring to the history of selection over a relatively long period of time (e.g., one week or longer). Further, the tendency such as the selection of similar channels on the same day of the week may be learned and reflected in the prediction.

The method of prediction may be other than the one shown in FIG. 5 or the one discussed above. For example, given that the controller 30 is provided with modules for channel selection other than the channel number designation buttons 60 and the channel up/down buttons 62 shown in FIG. 4, methods that allows efficient prediction may be appropriately selected based upon the input format of the modules or the tendency in the intention of the user using the modules. Conditional processing may be defined in further detail such that, even if an input is provided via the channel number designation buttons 60, a channel may be predicted similarly as in the case of providing an input using the channel up/down buttons 62 provided that the manipulation to choose successively larger or smaller channel numbers is observed.

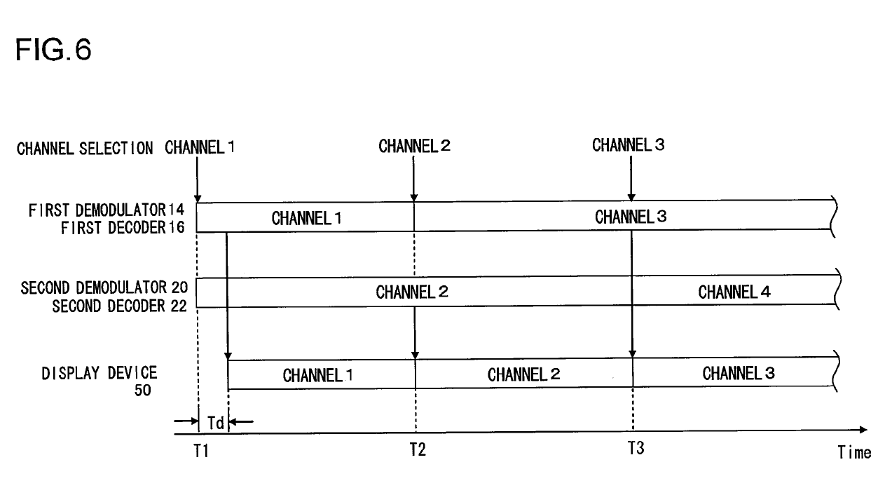

FIG. 6 is a schematic timing chart resulting when the channel is switched according to the present embodiment, covering a period between a channel selection input and display of an image. The charts are organized similarly as in FIG. 1. First, we postulate a state occurring immediately after the user started viewing a program or a situation where an input for channel selection has not been provided for a predetermined period of time and the sub-processing system is not in operation. It will be assumed that the first processing system 18 comprising the first demodulator 14 and the first decoder 16 is the main processing system at this point of time. When an input for selecting “channel 1” is provided at time T1 in this state, the first processing system 18 comprising the first demodulator 14 and the first decoder 16 starts demodulating and decoding the signal corresponding to “channel 1”. Naturally, since the demodulation and decoding of the signal corresponding to “channel 1” had not been carried out, the system 18 starts by extracting the signal at time T1. As a result, a time lag Td occurs before the image of “channel 1” is displayed on the display device. If the sub-processing system had been in operation but the predicted channel that had been processed there is other than “channel 1”, a time lag Td occurs similarly.

Meanwhile, the second processing system 24 comprising the second demodulator 20 and the second decoder 22 is started as the sub-processing system. The second processing system 24 starts demodulating and decoding the signal corresponding to the channel predicted by the channel predicting unit 32 (in the example of FIG. 6, “channel 2”). When an input for selecting “channel 2” as predicted is provided in this state at time T2, the output controlling unit 26 changes over between the main processing system and the sub-processing system by switching the source of the output of data stream to the video decoder 34 to the second decoder 22. The output controlling unit 26 may temporarily output the data for “channel 2” stored in the memory 36 to the video decoder 34, depending on the timing.

In this way, the display device 50 starts displaying the image of “channel 2” substantially at time T2, when the input for selecting the channel is provided. Meanwhile, the first demodulator 14 and the first decoder 16, which are turned into the sub-processing system, starts demodulating and decoding the signal corresponding to the channel newly predicted by the channel predicting unit 32 (in the example of FIG. 6, “channel 3”). When an input for selecting “channel 3” as predicted is provided at time T3, the display device 50 can immediately display the image of “channel 3” by changing over between the main processing system and the sub-processing system. The second demodulator 20 and the second decoder 22 starts demodulating and decoding the signal corresponding to the channel subsequently predicted (in the example of FIG. 6, “channel 4”).

In this embodiment, two processing systems are operated for image display. Therefore, image data for both of the two channels selected before and after a switching can be output for a short period of time including time T2 or time T3. In this respect, the output controlling unit 26 may control the generation of image data in the video decoder 34 such that the images of the two channels selected before and after a switching crossfade. For example, the image of “channel 1”, the channel selected prior to the switching at time T2, is allowed to fade out. Concurrently, the image of “channel 2”, the newly selected channel, is allowed to fade in.

For example, when zapping through channels, intermittent changing of channels and unrelated images coming into view one after another will give an impression of disorder to the user, who may feel stressed as a result. Particularly, the viewer who is with a user zapping through channels will feel increasingly uneasy as images are changed one after another at intervals determined by the other person. By allowing images of channels selected before and after a switching to crossfade for smooth transition, uneasiness can be lessened.

According to the embodiment described above, two processing systems are provided for demodulation and decoding of signals included in broadcast signals. One is a main processing system for processing a signal corresponding to a channel selected by the user. The other is a sub-processing system for processing a signal corresponding to a channel predicted to be selected next by the user. Accordingly, in the event that the predicted channel is actually selected, the image of the selected channel can be immediately displayed merely by switching the source of the output of data stream used to generate output image. Time lags between the selection of a channel and the display of the channel can be eliminated.

The method of predicting a channel is changed depending on the type of input module used by the user to select a channel. In this way, channels can be predicted more efficiently. For example, accurate prediction will be possible by considering the fact that, in the case of an input given via the channel up/down buttons, which are often used for zapping, channel numbers are often incremented or decremented in one direction. By its nature, zapping tend to give stress to the user due to a time lag occurring at the time of switching the channel. Substantial advantages will accrue by introducing the inventive method.

The two processing systems can be controlled to switchably play the role of a main processing system and a sub-processing system depending on the situation. Thus, when two channels are alternately selected (e.g., when periodically checking a program of interest in a competing timeslot), the image can be immediately switched by a minimum process of switching the source of the output of data stream to generate a display image. The fact that two channels are alternately selected can be predicted based upon the frequency of selection as measured over a short period of time.

An added advantage of providing two processing systems is that it is possible to simultaneously output the images of the channels selected before and after a switching as far as the processing of the signal corresponding to the predicted channel is not affected. By using this advantage and allowing the images of the two channels to crossfade, the stress of the user is further reduced, which adds to the benefit of minimization of the occurrence of time lags.

In the absence of an input for channel selection for a predetermined period of time, the sub-processing system is suspended. With this, reduction in power consumption can be prioritized in situations where channel switching is not so frequent. Operations advantageous in respective situations are automatically selected.

As described above, three or more processing systems may be provided so long as the manufacturing cost and computational cost permit. Two ore more channels may be predicted and respectively processed in two or more sub-processing systems. In this case, the frequency of “hits” in prediction will be higher than when two processing systems are provided. Accordingly, the frequency of time lags between the selection of a channel and the display of the image can be more successfully minimized.

Described above is an explanation based upon the embodiment. The embodiment is intended to be illustrative only and it will be obvious to those skilled in the art that various modifications to constituting elements and processes could be developed and that such modifications are also within the scope of the present invention.

The method described above in the embodiment is for use in receiving digital broadcast television images, but the application of the invention is not limited to digital broadcasting services. The invention can also be applied to any environment in which stream data corresponding to a plurality of channels are acquired substantially at the same time and subjected to a predetermined process so that one of the streams is output. For example, in a digital radio system, Internet television system, or a monitoring or observation system for monitoring or analyzing images captured at a plurality of locations on one output equipment, the occurrence of time lags associated with channel switching can be minimized by providing a plurality of processing systems and predicting channel selection as appropriate, as in the described embodiment.

What is claimed is:

1. A decoding apparatus adapted to decode a signal corresponding to a channel selected by a user, generate output data based upon resultant decoded data, and output the output data to a device connected to the decoding apparatus, the signal being included in broadcast signals, the decoding apparatus comprising:
a plurality of decoders operative to decode signals corresponding to a plurality of channels respectively, including the selected channel, the signal being included in the broadcast signals;
an output controlling unit operative to control the destination of output of the decoded data generated by the plurality of decoders so that the output data is generated based upon the decoded data corresponding to the selected channel; and
a channel predicting unit operative to predict a channel to be selected next every time the user selects a channel, wherein
one of the plurality of decoders decodes the signal corresponding to the selected channel, and the other decoders decode the signals corresponding to the channels predicted by the channel predicting unit.

2. The decoding apparatus according to claim 1, wherein when the user selects the channel predicted by the channel predicting unit, the output controlling unit controls the destination of output of the decoded data so that the output data is generated based upon the decoded data generated by the decoder which had been decoding a signal corresponding to the selected channel.

3. The decoding apparatus according to claim 1, wherein in response to the user's input for channel selection, the decoder, which had been decoding a signal corresponding to the channel selected prior to the input, starts decoding a signal corresponding to the channel predicted by the channel predicting unit to be selected next.

4. The decoding apparatus according to claim 1, wherein the channel predicting unit uses an algorithm selected from a plurality of prepared algorithms to predict a channel to be selected next, the selection being dependent on an input means used by the user to provide an input for channel selection.

5. The decoding apparatus according to claim 4, wherein if an input for channel selection is provided via one of channel up and down buttons for incrementing or decrementing channel numbers, respectively, the channel predicting unit predicts the channel having the same channel number that follows the selected channel number in the order of selection by the button used for input as being a channel to be selected next.

6. The decoding apparatus according to claim 1, wherein every time the user provides an input for channel selection, the channel predicting unit stores the selected channel number in a history of selection and recursively predicts a channel to be selected next by referring to the history of selection.

7. The decoding apparatus according to claim 6, wherein the channel predicting unit predicts a channel to be selected next based upon the frequency of selection of channels over a predetermined period of time in the past.

8. The decoding apparatus according to claim 1, wherein in the absence of an input for channel selection for a predetermined period of time, the decoders other than the decoder for decoding the selected channel suspends the respective processes.

9. The decoding apparatus according to claim 1, further comprising:
an image data generating unit operative to generate, as the output data, data for moving images to be displayed on a display device connected to the decoding apparatus, wherein in response to the user's input for channel selection, the output controlling unit controls the output of the decoded data to the image data generating unit so that data for moving images, in which images for the channel selected prior to the input fade out and images for the channel selected by the input fade in, is generated in the image data generating unit.

10. The decoding apparatus according to claim 1, further comprising:
a memory operative to store latest decoded data, in a predetermined amount, generated by the decoder for decoding the signal corresponding to the channel predicted by the channel predicting unit, wherein
immediately after the user selects the channel predicted by the channel predicting unit, the output controlling unit controls the output so that the output data is generated based upon the decoded data read out from the memory.

11. A decoding method adapted for a decoding apparatus, comprising:
1) outputting data which is obtained by decoding a signal corresponding to a channel selected by a user to a device connected to the decoding apparatus, the signal being included in broadcast signals;
2) decoding, in parallel with step 1), a signal corresponding to a channel predicted to be selected next; and
3) switching the destination of output so that data obtained by decoding the signal corresponding to the predicted channel in step 2) is output to the device, when the user selects the channel predicted.

12. The decoding method according to claim 11, further comprising:
4) predicting, every time the user provides an input for selection, a channel to be selected next, by using an algorithm dependent on a means used for the input.
